(19) United States
(12) Patent Application Publication
(10) Pub. No.: US 2007/0185897 A1
(43) Pub. Date: Aug. 9, 2007

(54) Method and system for tracking and storing semantic web revision history

(75) Inventors: Joseph P. Betz, Arlington, MA (US); Sean J. Martin, Webster, MA (US); Christopher R. Vincent, Arlington, MA (US)

Correspondence Address: SCULLY SCOTT MURPHY & PRESSER, PC, 400 GARDEN CITY PLAZA, SUITE 300, GARDEN CITY, NY, 11530, US

(73) Assignee: International Business Machines Corporation, Armonk, NY (US)

(21) Appl. No.: 11/348,187

(22) Filed: Feb. 6, 2006

(51) Int. Cl. G06F 7/00

(52) U.S. Cl. 707/102

(57) ABSTRACT

Disclosed are a method of and system for tracking and storing semantic web revision history. The method comprises the steps of providing a first semantic web statement, adding a unique identifier, such as a reification, of said statement, adding a revision statement including a revision number, and updating said first statement to form an updated semantic statement. When the first semantic statement is updated, a new semantic statement is created that captures said first semantic statement prior to being updated, said revision number is incremented, and said new statement is connected with said updated statement. In this way, a user has access to that first statement via the updated statement. Preferably, said first statement includes a set of properties, and each of these properties is an object of the reification of that first statement.

### BACKGROUND OF THE INVENTION

1. Field of the Invention

This invention generally relates to semantic web technology, and more specifically, to methods and systems for tracking and storing semantic web revision history. Even more specifically, the invention relates to such methods and systems that are particularly well suited for use with the Resource Description Framework (RDF) language.

2. Background Art

RDF is a language used to represent information, particularly meta data, about resources available in the World Wide Web. For example, RDF may be used to represent copyright or licensing information about a document on the Web, or the author and title of a particular Web page. RDF can also be employed for representing data or meta data about items or matters that can be identified on the World Wide Web even though these items cannot be directly retrieved from the Web. Examples of these latter items may include data about a user's Web preferences, and information, such as the price and availability, of items for sale at on-line shopping facilities. Specifications for RDF are established by the World Wide Web Consortium. The RDF specification also describes how to serialize RDF data for use in web services, etc. (e.g. RDF/XML).

RDF uses identifiers, referred to as Uniform Resource Identifiers, or URIs, and is based on a specific terminology. An RDF statement includes a subject, a predicate and an object. The subject identifies the thing, such as person or Web page, that the statement is about. The predicate identifies the property or characteristic, such as title or owner, of the subject of the RDF statement, and the object identifies a value of that property or characteristic. For example, if the RDF statement is about pet owners, the subject might be “owner,” the predicate could be “name,” and the object could be “Joe.” This format, among other advantages, allows RDF to represent statements as a graph of nodes and arcs. In the graph, the subjects and objects may be represented by, for example, ovals, circles or squares, or some combination thereof, while the predicates of the RDF statements may be represented by arcs or arrows connecting the subject of each statement with the object of the statement.

An important feature of RDF is that it provides a common framework for expressing information. This allows this information to be exchanged among applications without losing any meaning of the information. Because of this common framework, application developers can utilize the availability of common tools and parsers to process RDF information.

While the RDF specification describes a conceptual model for storing information, there is not a standard way to track changes in mutable data. Conventional RDF systems lack support for the modification of a specific reified statement. These systems simply remove the previous version of a statement and add a new, similar statement.

### SUMMARY OF THE INVENTION

An object of this invention is to track changes in mutable data.

Another object of the present invention is to provide a method and system for tracking and storing semantic web revision history.

A further object of the invention is to track changes to the objects of individual semantic web statements.

Another object of this invention is to support the modification of a semantic web statement such that its object is updated but the statement's unique URI stays the same.

These and other objectives are attained with a method of and system for tracking and storing semantic web revision history. The method comprises the steps of providing a first semantic web statement, adding a unique identifier of said statement, adding a revision statement including a revision number, and updating said first statement to form an updated semantic web statement. When the first semantic web statement is updated to form said updated semantic web statement, a new semantic web statement is created that captures said first semantic web statement prior to being updated, said revision number is incremented, and said new statement is connected with said updated statement, wherein a user has access to said first statement via the updated statement. Preferably, said first statement includes a set of properties, and the reification of said first statement includes a set of objects, each of said properties of the first statement being one of said objects of the reification of said first statement. Also, the unique identifier of the first semantic web statement may be provided by adding a reification of that statement, although other suitable mechanisms may be used to provide that unique identifier.

The preferred embodiment of the invention, described in detail below, builds on RDF's concept of reification to track changes to the objects of individual statements. This preferred embodiment supports the modification of a statement such that its object is updated but the statement's unique URI stays the same.

In this preferred embodiment, a revision property is added to statements, specifying an integer revision number. Each time the object of a statement is modified, the revision number is incremented. A remote RDF server can use the revision number to detect collisions when multiple clients attempt to update simultaneously. The client may specify that they are updating a statement and that they think they are submitting a specific revision. If that revision already exists, the update will fail, notifying the client of the conflict.

In addition, the preferred embodiment of this invention provides a format for storing previous revisions of a statement, as an additional RDF graph structure. This structure allows clients to look up previous revisions of a statement, using conventional RDF retrieval operations.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 shows a computer system that may be used to practice this invention.

FIG. 2 illustrates a graph structure for a standard RDF statement.

FIG. 3 depicts the RDF statement of FIG. 2 with a RDF reification quad added.

FIG. 4 shows a revision statement added to the graph of FIG. 3.

FIG. 5 depicts an update to the RDF statement of FIG. 5.

FIG. 6 illustrates a new statement added to the graph of FIG. 5. This new statement captures the previous revision of the RDF statement shown in FIG. 5.

### DETAILED DESCRIPTION OF THE PREFERRED EMBODIMENTS

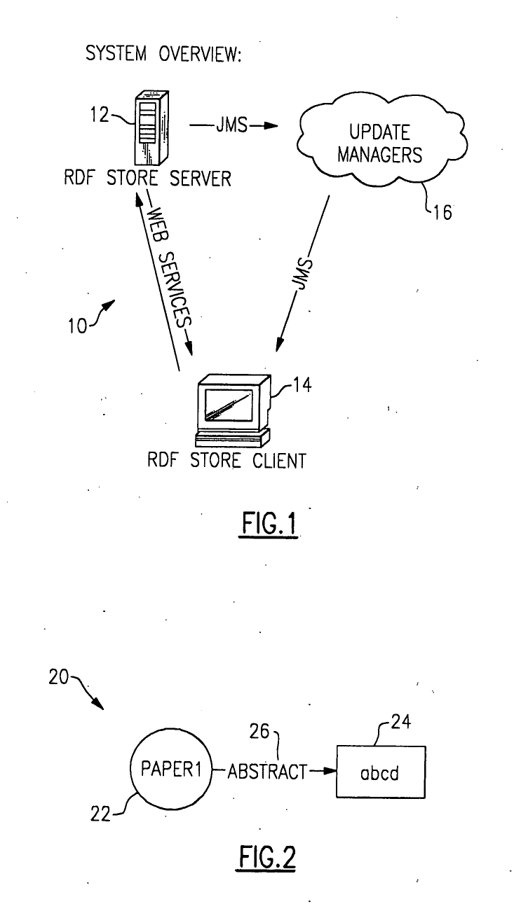

FIG. 1 illustrates a computer system 10 that may be used in the practice of this invention. In particular, FIG. 1 shows a server computer 12, a client computer 14, and a plurality of update managers 16. The devices of system 10 are connected together by any suitable network. Preferably, this network may be, for example, the Internet, but could also be an intranet, a local area network, a wide area network, or other networks. Also, as will be understood by those of ordinary skill in the rat, system 10 may include additional servers, clients and other devices not shown in FIG. 1.

Any suitable server 12 may be used in system 10, and for example, the server may be an IBM RS/6000 server. Also, the clients 14 of the system may be, for instance, personal computers, laptop computers, servers, workstations, main frame computers, or other devices capable of communicating over the network. Likewise, the devices of system 10 may be connected to the network using a wide range of suitable connectors or links, such as wire, fiber optics or wireless communication links.

As mentioned above, in the depicted example, the devices of system 10 may be connected together via the Internet, which is a worldwide collection of networks and gateways that use the TCP/IP suite of protocols to communicate with one another. In the operation of system 10, server 12 provides data and applications to the clients. Among other functions, the server and the clients store semantic web statements such as RDF statements. For this reason, as depicted in FIG. 1, server 12 is referred to as an RDF store server, and clients 14 are referred to as RDF store clients.

The update managers 16 of system 10 are used to distribute updates to those semantic web statements. The update managers subscribe to statement updates based on patterns provided by their clients, and listen for all transaction completion messages. Any suitable update managers and any suitable procedures for distributing updates may be used in the practice of this invention. For example, suitable update managers and suitable update distribution procedures are described in copending application no (Attorney Docket no. POU920050061US1) for “System And Method For Scalable Distribution Of Semantic Web Updates,” filed ______, the disclosure of which is hereby incorporated herein in its entirety by reference. Suitable update managers are also described in copending application no. (Attorney Docket No. POU920050060US1), for “Method And System For Selective Tracking Of Semantic Web Data Using Distributed Update Events,” filed ______, the disclosure of which is hereby incorporated herein in its entirety by reference.

A number of RDF storage systems are built on top of relational databases. Suitable relational databases are disclosed, for example, in copending application no. (Attorney Docket POU920050098US1) for “Method And System For Controlling Access To Semantic Web Statements,” filed ______, and copending application no. (Attorney Docket POU920050099US1), for “Method And System For Efficiently Storing Semantic Web Statements In A Relational Database,” filed—______, the disclosures of which are hereby incorporated herein in their entireties by reference.

The present invention is directed generally to tracking and archiving modifications to RDF statements. Generally, this invention builds on RDF's concept of reification to track changes to the objects of individual statements. Reification is a method of uniquely identifying a RDF statement and enables information about an RDF statement to be connected to that statement.

Also, the preferred embodiment of the invention supports the modification of a statement such that its object is updated but the structure's unique URI stays the same. FIGS. 2-6 illustrate this preferred procedure.

In the example shown in FIGS. 2-6, there exists a statement 20 asserting the abstract of a particular academic paper: <http:// . . . paper.pdf>--<abstract>-->“Models brain tumors using molecular dynamics.” Where the above statement has the URI <http:// . . . statement1>.

A user might want to create a new statement that references the paper's abstract, but wants that statement to remain valid even if the abstract is edited. Rather than referencing the actual abstract, the user requires a reference to the statement itself. <http:// . . . statement1>--<annotation>→“This is a useful abstract.” FIGS. 2-6 show more specifically how this is done.

FIG. 2 shows a standard RDF statement 20 including a subject 22, an object 24, and a predicate 26. The subject of this Statement is the above-mentioned identified as “paper1”, the predicate of the Statement is “abstract”, and the subject statement is the Abstract of the paper, represented as “abcd.”

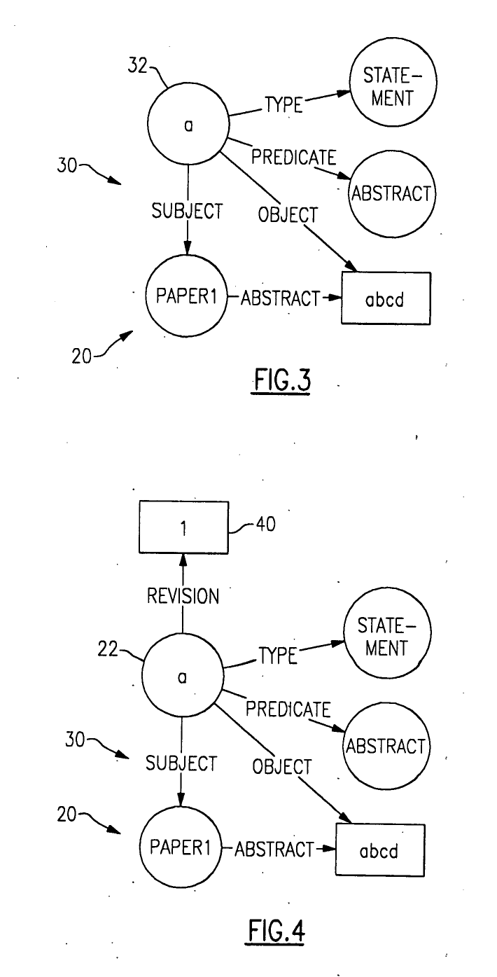

A unique identifier, preferably a standard reification quad 30, is added to the RDF statement of FIG. 2 to form the graph of FIG. 3. This quad includes four statements, each having a subject, a predicate and an object. All four statements have the same subject 32, identified as “a.” The predicates of these four statements are four aspects of the original RDF statement: “type”, “predicate”, “object” and “subject”. The four objects of the four additional statements are, respectively, “Statement”, “abstract”, “abcd”, and “paper1”.

As shown in FIG. 4, the next step in the implementation of this example is to add a revision statement 40 to the reification information. This revision property specifies an integer revision number. Each time the object of a statement is modified, the revision number is incremented. A remote RDF server can use the revision number to detect collisions when multiple clients attempt to update simultaneously. The client may specify that they are updating a statement and that they think they are submitting a specific revision. If that revision already exists, the update will fail, notifying the client of the conflict.

The subject, predicate and object of this revision statement shown in FIG. 4 are, respectively, “a”, “revision” and “1”, which identifies the associated RDF statement.

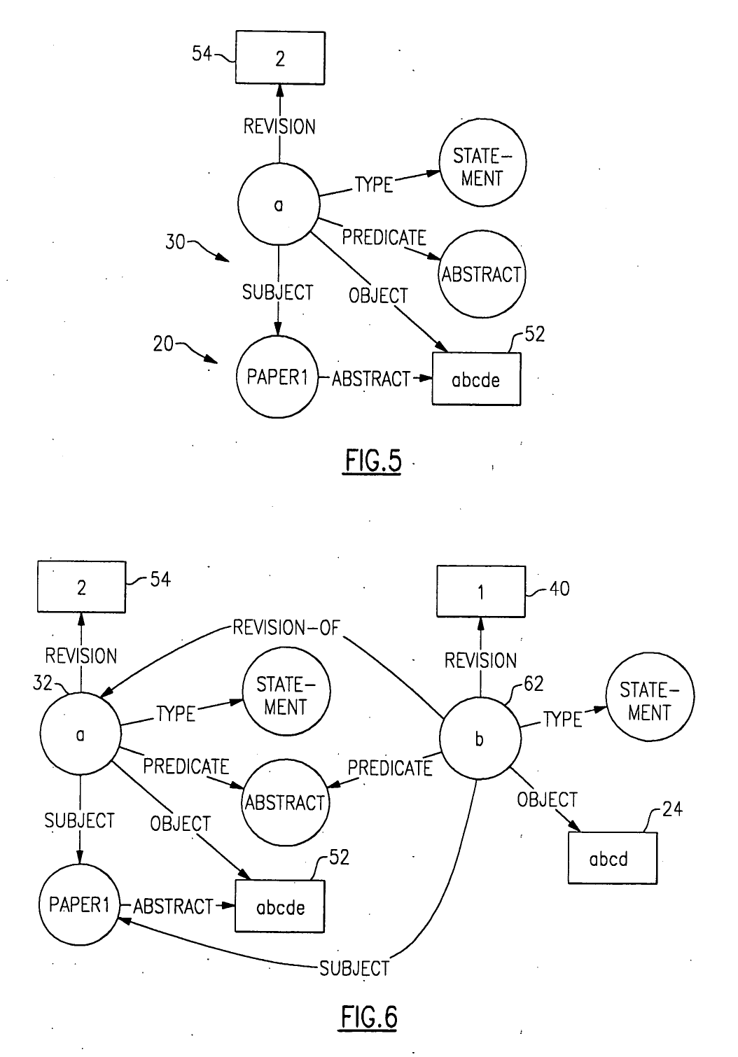

At this point, a client can change the actual abstract in the paper without losing the information in the original RDF statement. FIGS. 5 and 6 show how this is done.

When the abstract of the paper is changed, the content of “abcd” changes, as represented by box 52 of FIG. 5. At this time, the object of the revision statement is changed, as shown at 54, to “2”, indicating that the new version of RDF is the second version of that statement.

Also, as shown in FIG. 6, a set of six additional statements is added to the graph. Each of these statements has the same subject, “b”, shown at 62, indicating that this set of statements was added next after “a” was added. These six statements include the five predicates of set “a” of FIG. 5—namely, “revision”, “type”, “predicate”, “object” and “subject”—and an additional predicate “revision of.” In the set of FIG. 6, the objects of “revision”, “type” and “object” are, respectively, “1”, “statement” and “abce”. Also, the objects of “subject”, “predicate” and “revision of” are, respectively, “paper1”, “abstract” and “a”.

The information in the graph of FIG. 6 thus captures all the information of the previous revision of the RDF statement in FIGS. 2 and 3. Clients may use the “revision of” predicate to locate all the previous revisions of a reified statement.

The preferred embodiment of the invention thus provides a method, and the resulting RDF graph structures, for tracking and archiving modifications to RDF statements. This embodiment of the invention does not depend on a specific serialization (encoding) technique. Neither the RDF specification nor this invention depends on how an RDF graph is actually stored by a host computer (database, filesystem, etc.).

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or of the functional tasks of the invention, could be utilized.

The present invention can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of tracking and storing semantic web revision history, comprising the steps of:
providing a first semantic web statement;
adding a unique identifier of said statement;
adding a revision statement including a revision number;
updating said first statement to form an updated semantic web statement; and
when the first semantic web statement is updated to form said updated semantic web statement, performing the steps comprising:
i) creating a new semantic web statement that captures said first semantic web statement prior to being updated,
ii) incrementing said revision number, and
iii) connecting said new statement with said updated statement, wherein a user has access to said first statement via the updated statement.

2. The method according to claim 1, wherein said first statement includes a set of properties, and the unique identifier of said first statement includes a set of objects, each of said properties of the first statement being one of said objects of the unique identifier of said first statement.

3. The method according to claim 2, wherein the step of adding the revision statement includes the step of adding said revision number as one of the objects of the unique identifier of said first statement.

4. The method according to claim 1, wherein said first semantic web statement includes a defined object, and the step of creating the new semantic web statement includes the step of copying said defined object into said new semantic web statement.

5. The method according to claim 1, wherein said first statement includes a set of properties, and the new semantic web statement includes a set of objects, each of said properties of the first statement being one of said objects of said new statement.

6. The method according to claim 1, comprising the further step of expressing said first semantic web statement, said unique identifier of said first statement, said revision statement, and said new semantic web statement in a graphical form.

7. A computer system for tracking and storing semantic web revision history, said computer system including instructions for:
providing a first semantic web statement;
adding a unique identifier of said statement;
adding a revision statement including a revision number;
updating said first statement to form an updated semantic web statement; and
when the first semantic web statement is updated to form said updated semantic web statement, performing the steps comprising (i) creating a new semantic web statement that captures said first semantic web statement prior to being updated, (ii) incrementing said revision number, and (iii) connecting said new statement with said updated statement, wherein a user has access to said first statement via the updated statement.

8. The computer system according to claim 7, wherein said first statement includes a set of properties, and the unique identifier of said first statement includes a set of objects, each of said properties of the first statement being one of said objects of the unique identifier of said first statement.

9. The computer system according to claim 8, wherein the instructions for adding the revision statement includes instructions for adding said revision number as one of the objects of the reification of said first statement.

10. The computer system according to claim 7, wherein said first semantic web statement includes a defined object, and the instructions for creating the new semantic web statement includes instructions for copying said defined object into said new semantic web statement.

11. The computer system according to claim 7, wherein said first statement includes a set of properties, and the new semantic web statement includes a set of objects, each of said properties of the first statement being one of said objects of said new statement.

12. The computer system according to claim 7, wherein said instructions further include instructions for expressing said first semantic web statement, said unique identifier of said first statement, said revision statement, and said new semantic web statement in a graphical form.

13. A program storage device readable by machine, tangibly embodying a program of instructions executable by the machine to perform method steps for tracking and storing semantic web revision history, said method steps comprising:
providing a first semantic web statement;
adding a unique identifier of said statement;
adding a revision statement including a revision number;
updating said first statement to form an updated semantic web statement; and
when the first semantic web statement is updated to form said updated semantic web statement, performing the steps comprising:
i) creating a new semantic web statement that captures said first semantic web statement prior to being updated,
ii) incrementing said revision number, and
iii) connecting said new statement with said updated statement, wherein a user has access to said first statement via the updated statement.

14. The program storage device according to claim 13, wherein said first statement includes a set of properties, and the unique identifier of said first statement includes a set of objects, each of said properties of the first statement being one of said objects of the unique identifier of said first statement.

15. The program storage device according to claim 14, wherein the step of adding the revision statement includes the step of adding said revision number as one of the objects of the unique identifier of said first statement.

16. The program storage device according to claim 13, wherein said first semantic web statement includes a defined object, and the step of creating the new semantic web statement includes the step of copying said defined object into said new semantic web statement.

17. The program storage device according to claim 13, wherein said first statement includes a set of properties, and the new semantic web statement includes asset of objects, each of said properties of the first statement being one of said objects of said new statement.

18. The program storage device according to claim 13, wherein said method steps comprise the further step of expressing said first semantic web statement, said unique identifier of said first statement, said revision statement, and said new semantic web statement in a graphical form.
